(19) United States
(12) Patent Application Publication
(10) Pub. No.: US 2017/0159446 A1
(43) Pub. Date: Jun. 8, 2017

(54) METHODS AND SYSTEMS FOR DETERMINING WEAR IN A TURBINE ENGINE

(71) Applicant: General Electric Company, Schenectady, NY (US)

(72) Inventors: Jonathan William Graham, Greer, SC (US); Paul Michael Kienitz, Ely, MN (US); Jacob Andrew Salm, Mauldin, SC (US)

(21) Appl. No.: 14/956,641

(22) Filed: Dec. 2, 2015

(51) Int. Cl. F01D 5/14; F01D 11/12

(52) U.S. Cl. CPC F01D 5/147; F01D 11/122; F05D 2220/31; F05D 2240/307; F05D 2240/128; F05D 2260/80

(57) ABSTRACT

A turbine engine system includes a component positioned such that the component is subject to wear. The component includes an outer surface configured to be subjected to wear and a wear indication feature formed in the outer surface. The wear indication feature includes a first dimension at the outer surface and a second dimension at an inward location relative to the outer surface. The second dimension is different from the first dimension.

### BACKGROUND

The subject matter disclosed herein relates generally to turbine engines and more particularly, to a methods and systems for determining rotor blade wear in turbine engines.

At least some known turbines have a defined flow path that includes, in serial-flow relationship, an inlet, a turbine, and an outlet. At least some known turbines also include a plurality of stationary stators that direct a fluid flow towards a rotor assembly that includes at least one row of turbine buckets (blades) that are circumferentially-spaced about a rotor disk. The fluid flow channeled to the rotor assembly from the stationary stators impacts airfoils of the turbine buckets to induce rotation of the rotor assembly.

During operation of a gas turbine engine, a turbine blade can tilt or expand due to creep from exposure to a high temperature fluids and centrifugal forces. When a tip of the turbine blade contacts a casing of the gas turbine engine, the tip can wear over time. At least some known turbine blades are able to withstand a certain amount of wear before requiring replacement. Typically, to inspect a turbine for quantitative wear of the turbine blades, the turbine is disassembled and the blades are removed and taken to a service center. Precise instrumentation is then used at the service center to measure various parameters of the turbine blades to qualitatively determine an amount of wear on the blades and also a determination of the remaining service lifetime of the blade. Such inspection methods require a significant amount of turbine outage time and also increased maintenance and service costs associated with turbine disassembly and measurement equipment usage.

### BRIEF SUMMARY

In one aspect, a turbine engine system is provided. The turbine engine system includes a component positioned such that the component is subject to wear. The component includes an outer surface configured to be subjected to wear and a wear indication feature formed in the outer surface. The wear indication feature includes a first dimension at the outer surface and a second dimension at an inward location relative to the outer surface. The second dimension is different from the first dimension.

In another aspect, a method of servicing a turbine engine is provided. The method includes forming at least one wear indication feature on a component of the turbine engine, wherein the at least one wear indication feature includes a first dimension. The method also includes operating the turbine engine such that the component is subjected to wear. The wear indication feature is then measured to determine a second dimension of the wear indication feature. A wear condition of the component is then determined based on the second dimension.

In yet another aspect, a wear indication system is provided. The wear indication system includes a stationary component and a rotating component positioned proximate the stationary component. The rotating component includes a radially outer surface configured to contact the stationary component. The wear indication system also includes a wear indication feature formed in the radially outer surface. The wear indication feature includes a first dimension at the radially outer surface and a second dimension at a radially inward location of the radially outer surface. The second dimension is different from the first dimension.

### BRIEF DESCRIPTION OF THE DRAWINGS

FIG. 1 is a schematic view of an exemplary steam turbine engine;

FIG. 2 is a schematic view of a portion of the steam turbine engine shown in FIG. 1 and taken along area 2;

FIG. 3 is a perspective view of an exemplary turbine bucket that may be used in the turbine engine shown in FIG. 2 illustrating an exemplary embodiment of a wear indication feature;

FIG. 4 is a view of an alternative turbine bucket that may be used in the turbine engine shown in FIG. 2 and illustrating an alternative embodiment of a wear indication feature;

FIGS. 5-9 are alternative embodiments of a wear indication feature that may be used with the turbine bucket shown in FIGS. 3 and 4;

### DETAILED DESCRIPTION

The exemplary apparatus and methods described herein overcome at least some disadvantages of known systems and methods for use in determining an amount of wear of an internal component of a turbine. Moreover, the apparatus and methods described herein enable a reliable quantitative determination of the amount of wear of the internal component of the turbine to be determined. More specifically, the embodiments described herein each include at least one wear indication feature formed on a radially outer surface of an internal component of the turbine, such as a bucket tip cover. The wear indication feature includes a first dimension at the radially outer surface. When wear occurs, the radially outer surface is worn down such that the wear indication feature includes a second dimension radially inward of the initial radially outer surface. Without removing the buckets from the turbine engine, the second dimension can be measured and compared to the first dimension to determine the wear condition associated with the remaining service lifetime of the component. Although the illustrated apparatus and methods described herein are directed toward a steam turbine, the present disclosure is not limited to steam turbines. Thus, the scope of the present disclosure encompasses other types of turbines, including, but not limited to, gas and water turbines.

As used herein, the term “turbine bucket” is used interchangeably with the term “bucket” and thus can include any combination of a bucket that includes a platform and a dovetail, and/or a bucket that is integrally formed with a rotor disk, either embodiment of which may include at least one airfoil segment.

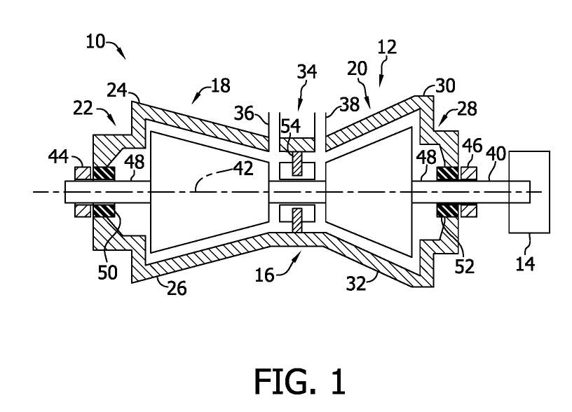

FIG. 1 is a schematic view of an exemplary turbine engine 10. In the exemplary embodiment, turbine engine 10 is an opposed-flow, high-pressure and intermediate-pressure steam turbine combination. Alternatively, turbine engine 10 is any type of steam turbine, such as, without limitation, a low-pressure turbine, a single-flow steam turbine, and/or a double-flow steam turbine. In another alternative embodiment, turbine engine 10 is a gas turbine engine. In the exemplary embodiment, turbine engine 10 includes a turbine 12 that is coupled to a generator 14 via a rotor assembly 16. Moreover, in the exemplary embodiment, turbine 12 includes a high pressure (HP) section 18 and an intermediate pressure (IP) section 20. An HP casing 22 is divided axially into upper and lower half sections 24 and 26, respectively. Similarly, an IP casing 28 is divided axially into upper and lower half sections 30 and 32, respectively. A central section 34 extends between HP section 18 and IP section 20, and includes an HP steam inlet 36 and an IP steam inlet 38. Rotor assembly 16 extends between HP section 18 and IP section 20 and includes a rotor shaft 40 that extends along a centerline axis 42 between HP section 18 and IP section 20. Rotor shaft 40 is supported from casing 22 and 28 by journal bearings 44 and 46, respectively, that are each coupled to opposite end portions 48 of rotor shaft 40. Steam seal units 50 and 52 are coupled between rotor shaft end portions 48 and casings 22 and 28 to facilitate sealing HP section 18 and IP section 20.

An annular divider 54 extends radially inwardly between HP section 18 and IP section 20 from central section 34 towards rotor assembly 16. More specifically, divider 54 extends circumferentially about rotor assembly 16 between HP steam inlet 36 and IP steam inlet 38.

During operation, steam is channeled to turbine 12 from a steam source, for example, a power boiler (not shown), wherein steam thermal energy is converted to mechanical rotational energy by turbine 12, and subsequently electrical energy by generator 14. More specifically, steam is channeled through HP section 18 from HP steam inlet 36 to impact rotor assembly 16 positioned within HP section 18 and to induce rotation of rotor assembly 16 about axis 42. Steam exits HP section 18 and is channeled to a boiler (not shown) that increases a temperature of the steam to a temperature that is approximately equal to a temperature of steam entering HP section 18. Steam is then channeled to IP steam inlet 38 and to IP section 20 at a reduced pressure than a pressure of the steam entering HP section 18. The steam impacts the rotor assembly 16 that is positioned within IP section 20 to induce rotation of rotor assembly 16.

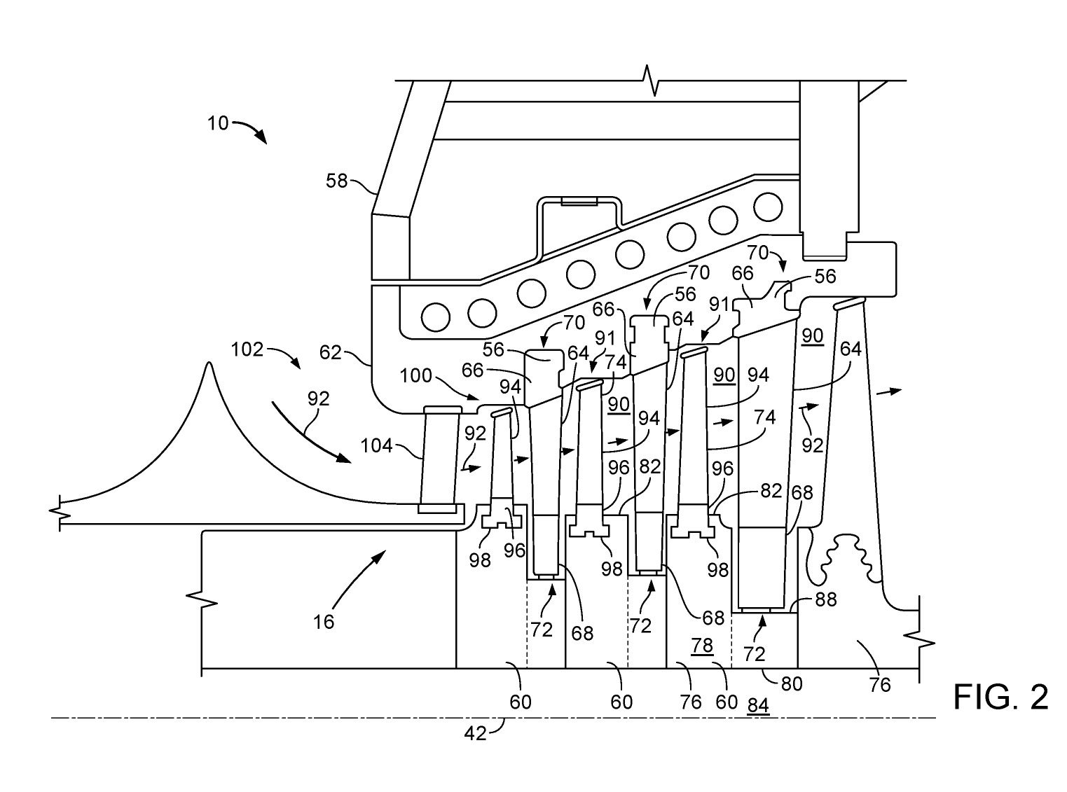

FIG. 2 is a schematic view of a portion of turbine engine 10 taken along area 2. In the exemplary embodiment, turbine engine 10 includes rotor assembly 16, a plurality of stator assemblies 56, and a casing 58 that extends circumferentially about rotor assembly 16 and stator assemblies 56. Rotor assembly 16 includes a plurality of rotor disk assemblies 60 that are each aligned substantially axially between each adjacent pair of stator assemblies 56. Each stator assembly 56 is coupled to casing 58, and casing 58 includes a nozzle carrier 62 that extends radially inwardly from casing 58 towards rotor assembly 16. Each stator assembly 56 is coupled to nozzle carrier 62 to facilitate preventing stator assembly 56 from rotating with respect to rotor assembly 16. Each stator assembly 56 includes a plurality of circumferentially-spaced nozzles 64 that extend from a radially outer portion 66 to a radially inner portion 68. Nozzle outer portion 66 is positioned within a recessed portion 70 defined within nozzle carrier 62 to enable stator assembly 56 to couple to nozzle carrier 62. Nozzle inner portion 68 is positioned adjacent to rotor disk assembly 60. In one embodiment, inner portion 68 includes a plurality of sealing assemblies 72 that form a tortuous sealing path between diaphragm assembly 56 and rotor disk assembly 60.

In the exemplary embodiment, each rotor disk assembly 60 includes a plurality of turbine buckets 74 that are each coupled to a rotor disk 76. Rotor disk 76 includes a disk body 78 that extends between a radially inner portion 80 and a radially outer portion 82. Radially inner portion 80 defines a central bore 84 that extends generally axially through rotor disk 76. Disk body 78 extends radially outwardly from central bore 84, and extends generally axially between an upstream member 86 to an opposite downstream member 88. Rotor disk 76 is coupled to an adjacent rotor disk 76 such that upstream member 86 is coupled to an adjacent downstream member 88.

Each turbine bucket 74 is coupled to rotor disk outer portion 82 such that buckets are circumferentially-spaced about rotor disk 76. Each turbine bucket 74 extends radially outwardly from rotor disk 76 towards casing 58. Adjacent rotor disks 76 are coupled together such that a gap 90 is defined between each axially-adjacent row 91 of circumferentially-spaced turbine buckets 74. Nozzles 64 are spaced circumferentially about each rotor disk 76 between adjacent rows 91 of turbine buckets 74 to channel steam downstream towards turbine buckets 74. A steam flow path 92 is defined between turbine casing 58 and each rotor disk 76.

In the exemplary embodiment, each turbine bucket 74 is coupled to an outer portion 82 of a respective rotor disk 76 such that each turbine bucket 74 extends into steam flow path 92. More specifically, each turbine bucket 74 includes an airfoil 94 that extends radially outwardly from a dovetail 96. Each dovetail 96 is inserted into a dovetail groove 98 defined within an outer portion 82 of rotor disk 76 to enable turbine bucket 74 to be coupled to rotor disk 76.

In the exemplary embodiment, turbine engine 10 also includes a wear indication system 100 having a stationary component, such as but not limited to casing 58 and carrier 62. The stationary component is positioned proximate a rotating component, such as but not limited to turbine bucket 74, and more specifically, a tip cover (not shown in FIG. 2) of bucket 74. During operation of turbine engine 10, steam is channeled into turbine 12 through a steam inlet 102 and into steam flow path 92. Each inlet nozzle 104 and stator assemblies 56 channel the steam towards turbine buckets 74. As steam impacts each turbine bucket 74, turbine bucket 74 and rotor disk 76 are rotated circumferentially about axis 42. Wear indication system 100 facilitates indicating an amount of wear on turbine buckets 74 due to contact between buckets 74 and carrier 62 of casing 58, as described in further detail below.

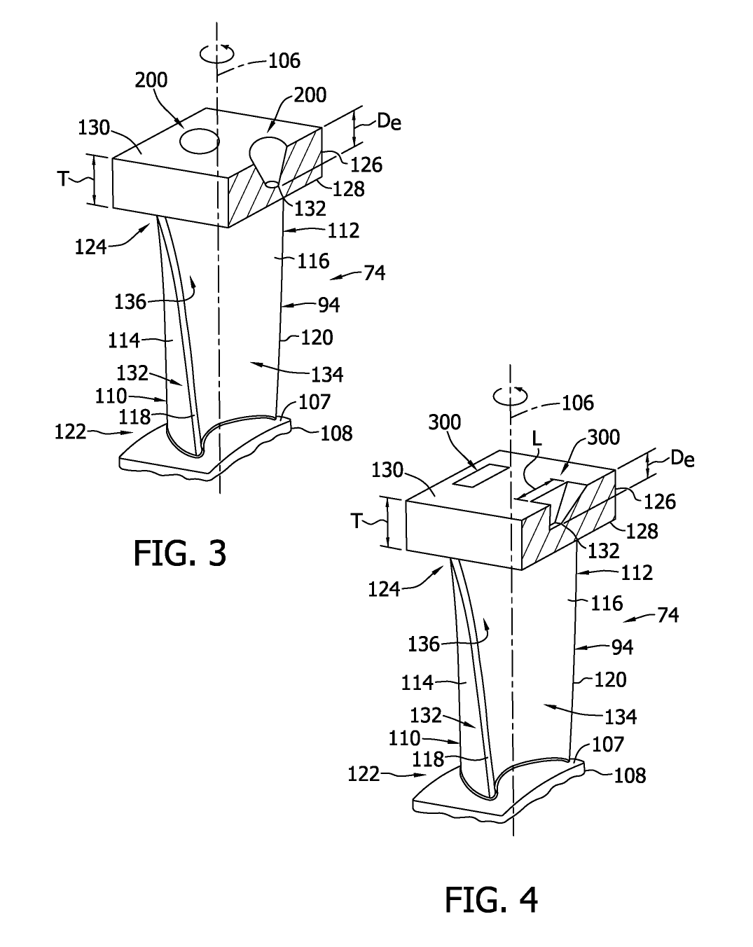

FIG. 3 is a perspective view of an exemplary turbine bucket 74 that may be used in turbine engine 10 (shown in FIG. 2) illustrating an exemplary embodiment of a wear indication feature 200. FIG. 4 is a view of an alternative turbine bucket 74 that may be used in turbine engine 10 illustrating an alternative embodiment of a wear indication feature 300. It is understood that each bucket 74 in the corresponding rotor disk assembly 60 may be substantially identical or alternatively, at least some of the other buckets in assembly 60 may be different than bucket 74. In the exemplary embodiment, turbine bucket 74 includes airfoil 94, a platform 107, and a shank 108. (Dovetail 96 is removed for clarification purposes only.) Airfoil 94 includes a first sidewall 110 and an opposite second sidewall 112. In the exemplary embodiment, first sidewall 110 is convex and defines a suction side 114 of airfoil 94, and second sidewall 112 is concave and defines a pressure side 116 of airfoil 94. First sidewall 110 is coupled to second sidewall 112 along a leading edge 118 and along an opposite trailing edge 120. More specifically, airfoil trailing edge 120 is spaced chord-wise and downstream from airfoil leading edge 118. First sidewall 110 and second sidewall 112 each extend radially outwardly from a blade root 122 towards an airfoil tip 124. Blade root 122 extends from platform 107. In the exemplary embodiment, a tip cover 126 is coupled to airfoil tip 124 adjacent to nozzle carrier 62. Tip cover 126 may include a plurality of sealing assemblies (not shown) that form a tortuous sealing path between nozzle carrier 62 and turbine bucket 74.

In the exemplary embodiment, tip cover 126 includes a bottom surface 128, a top surface 130, and an exemplary wear indication feature 200. Feature 200 is used to quantitatively determining an amount of wear on tip cover 126 and an associated remaining service lifetime of tip cover 126 or bucket 74. In the exemplary embodiment, during certain operating modes of turbine engine 10 (shown in FIG. 2), radially outer surface 130 contacts an inner surface of stationary carrier 62 (shown in FIG. 2) such that a thickness T of tip cover 126 changes over the service lifetime of bucket 74. In the exemplary embodiment, wear indication feature 200 includes a frustoconical-shaped cavity formed in radially outer surface 130 that extends a depth Dₑ toward inner surface 128 to a location 132 radially inward of, or normally inward to, outer surface 130. In the exemplary embodiment, depth Dₑ is approximately midway between surfaces 128 and 130. Alternatively, depth Dₑ is any depth that facilitates operation of wear indication feature 200 as described herein.

As shown in FIG. 3, the frustoconical shape of wear indication feature 200 includes a substantially circular shape at outer surface 130 and also at location 132 such that wear indication feature 200 includes a first dimension at radially outer surface 130 and a second dimension at radially inward location 132. As described in further detail below, because of the frustoconical shape, the first and second dimensions of wear indication feature 200 include different circle diameters.

Alternatively, as shown in FIG. 4, wear indication feature 300 includes a substantially rectangular slot or groove formed in outer surface 130 and also at location 132. As described in further detail below, wear indication feature 300 includes tapered walls that define a first dimension at radially outer surface 130 and a second dimension at radially inward location 132. Specifically, the first and second dimensions of wear indication feature 300 include different lengths at radially outer surface 130 and radially inner location.

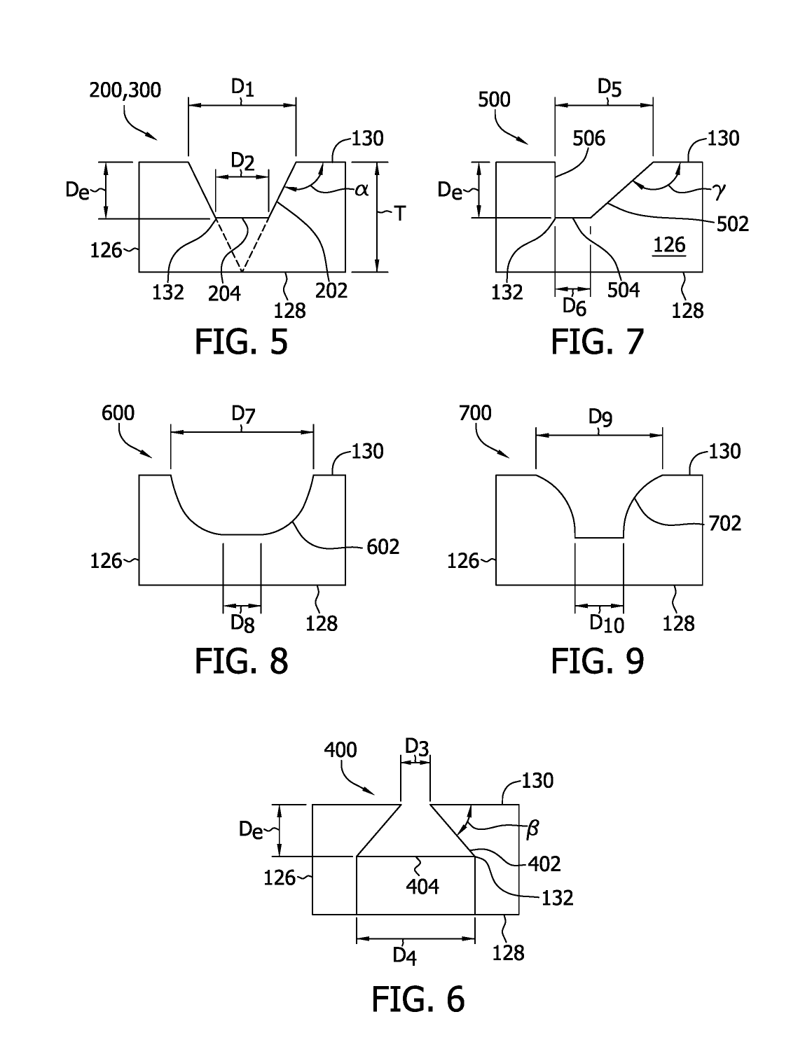

FIG. 5 illustrates a cross-sectional view of wear indication feature 200. Although described as wear indication feature 200, wear indication feature is similar in cross-section to FIG. 5. In the exemplary embodiment, wear indication feature 200 includes an annular tapered sidewall 202 and an endwall 204. Sidewall 202 extends between radially outer surface 130 and endwall 204 at radially inward location 132. More specifically, sidewall 202 extends radially inward at an oblique angle a with respect to radially outer surface 130 a depth Dₑ to endwall 204. In an alternative embodiment, annular sidewall 202 extends obliquely any depth other than depth Dₑ at any angle. For example, in one embodiment, annular sidewall 202 extends substantially entire thickness T of tip cover 126 to inner surface 128, as shown in dashed line in FIG. 5. Generally, annular sidewall 202 extends obliquely a predetermined depth associated with a wear condition of tip cover 126.

In the exemplary embodiment, wear indication feature 200 is tapered inward as it extends into tip cover 126. More specifically, wear indication feature 200 includes a first dimension D1 at radially outer surface 130 and a second dimension D2 at endwall 204 that is smaller than first dimension D1. As described above, because wear indication feature 200 is frustoconical in shape, first and second dimensions D1 and D2 are diameters of associated circles at outer surface 130 and at endwall 204, respectively. In the embodiment shown in FIG. 4, wear indication feature 300 is a tapered groove, so first and second dimensions D1 and D2 define lengths of the groove at outer surface 130 and at endwall 204.

In operation, wear indication feature 200 is formed in outer surface 130 of tip cover 126 and includes first dimension D1 at outer surface 130. When turbine 10 rotates, outer surface 130 of tip cover 126 contacts carrier 62 and thickness T of tip cover 126 decreases over time as radially outer surface 130 is worn away towards inner surface 128. After a predetermined period of operation, carrier 62 is removed to expose tip covers 126 for visual inspection. Without removing buckets 74 from turbine engine 10, a service operator is able to measure the diameter of wear indication feature 200 at a radially inward location of radially outer surface 130, for example, at location 132. The service operator then compares the measured second diameter D2 at radially inward location 132 to the initial first diameter D1 of wear indication feature 200 at radially outer surface 130 to determine a wear condition of the tip cover 126 such that the wear condition is based on the second diameter D2. Knowing the wear condition, the remaining service lifetime of tip cover 126 and/or bucket 74 is determined using a reference table or chart that associates the determined wear condition with corresponding remaining service lifetimes. As such, the remaining service lifetime of tip cover 126 and/or bucket 74 can be determined by simple visual inspection and a single measurement of wear indication feature 200 without requiring tip cover 126 and/or bucket 74 to be removed from turbine 10 and taken to a service center for analysis.

FIG. 6 illustrates an alternative wear indication feature 400 that may be used with tip cover 126. In this embodiment, wear indication feature 400 includes an annular tapered sidewall 402 and an endwall 404. Sidewall 402 extends between radially outer surface 130 and endwall 404 at radially inward location 132. More specifically, sidewall 402 extends radially inward at an oblique angle 13 with respect to radially outer surface 130 a depth Dₑ to endwall 404. In an alternative embodiment, annular sidewall 402 extends obliquely any depth other than depth Dₑ at any angle. For example, in one embodiment, annular sidewall 202 extends substantially entire thickness T of tip cover 126 to inner surface 128. Generally, annular sidewall 402 extends obliquely a predetermined depth associated with a wear condition of tip cover 126.

In this embodiment, wear indication feature 400 is tapered outward as it extends into tip cover 126. More specifically, wear indication feature 400 includes a third dimension D3 at radially outer surface 130 and a fourth dimension D4 at endwall 404 that is larger than third dimension D3. As described above, because wear indication feature 400 is frustoconical in shape, third and fourth dimensions D3 and D4 are diameters of associated circles at outer surface 130 and at endwall 204, respectively.

FIG. 7 illustrates another alternative wear indication feature 500 that may be used with tip cover 126. In this embodiment, wear indication feature 500 includes a first sidewall 502, an endwall 504, and a second sidewall 406. Sidewall 502 extends between radially outer surface 130 and endwall 504 at radially inward location 132. More specifically, sidewall 502 extends radially inward at an oblique angle y with respect to radially outer surface 130 a depth Dₑ to endwall 504. In an alternative embodiment, annular sidewall 502 extends obliquely any depth other than depth Dₑ at any angle. For example, in one embodiment, sidewall 502 extends substantially entire thickness T of tip cover 126 to inner surface 128. Generally, annular sidewall 202 extends obliquely a predetermined depth associated with a wear condition of tip cover 126. Additionally, second sidewall 506 extends substantially perpendicularly from radially outer surface 130 to ward endwall 504. Wear indication feature 500 illustrates that symmetric indication features are not required to determine the wear condition of tip cover 126. In this embodiment, sidewall 502 of wear indication feature 500 is tapered outward as it extends into tip cover 126. More specifically, wear indication feature 500 includes a fifth dimension D5 at radially outer surface 130 and a sixth dimension D6 at endwall 504 that is smaller than fifth dimension D5.

FIG. 8 illustrates another alternative wear indication feature 600 that may be used with tip cover 126. In this embodiment, wear indication feature 600 includes a sidewall 602 and an endwall 604. Sidewall 602 extends between radially outer surface 130 and endwall 604 at radially inward location 132. More specifically, sidewall 602 follows an arcuate path radially inward from radially outer surface 130 a depth De to endwall 604. That is, sidewall 602 is arcuately shaped, and, more specifically, concave when compared to wear indication feature 200 such that wear indication feature 600 is substantially U-shaped in cross-section. Wear indication feature 600 includes a seventh dimension D7 at radially outer surface 130 and an eighth dimension D8 at endwall 504 that is smaller than seventh dimension D7.

FIG. 9 illustrates another alternative wear indication feature 700 that may be used with tip cover 126. In this embodiment, wear indication feature 700 includes a sidewall 702 and an endwall 704. Sidewall 702 extends between radially outer surface 130 and endwall 704 at radially inward location 132. More specifically, sidewall 702 follows an arcuate path radially inward from radially outer surface 130 a depth De to endwall 704. That is, sidewall 702 is arcuately shaped, and, more specifically, convex when compared to wear indication feature 200 such that wear indication feature 700 is substantially U-shaped in cross-section. Wear indication feature 700 includes a ninth dimension D9 at radially outer surface 130 and a tenth dimension D10 at endwall 504 that is smaller than ninth dimension D9.

Although the wear indication system is shown and described herein as including a stationary component and a rotating component having a wear indication feature, other embodiments of the wear indication system are contemplated. For example, in one embodiment, the above-described wear indication feature is formed on a stationary component that contacts a rotating component. In another embodiment, the wear indication is formed on one or more stationary components that contact each other due to vibrations in the turbine engine. In yet another embodiment, the wear indication feature is formed on either a stationary or a rotating component that is subject to wear. For example, the wear indication feature is formed on the airfoil portion of a turbine blade, or any other component that does not contact another component in operation, and is subject to wear due to impingement from the flow of high speed, high temperature combustion gases flowing thereby.

The exemplary apparatus and methods described herein overcome at least some disadvantages of known systems and methods for use in determining an amount of wear of an internal component of a turbine. Moreover, the apparatus and methods described herein enable a reliable quantitative determination of the amount of wear of the internal component of the turbine to be determined. More specifically, the embodiments described herein each include at least one wear indication feature formed on a radially outer surface of an internal component of the turbine, such as a bucket tip cover. The wear indication feature includes a first dimension at the radially outer surface. When wear occurs, the radially outer surface is worn down such that the wear indication feature includes a second dimension radially inward of the initial radially outer surface. Without removing the buckets from the turbine engine, the second dimension can be measured and compared to the first dimension to determine the wear condition associated with the remaining service lifetime of the component. As such, the remaining service lifetime of tip cover and/or bucket can be determined by simple visual inspection and a single measurement of wear indication feature without requiring tip cover and/or bucket to be removed from turbine and taken to a service center for analysis.

Furthermore, the wear indication feature described herein includes any feature that is visibly distinct from the surrounding structure. For example, the wear indication feature includes a different color material that is exposed after a predetermined amount of wear. Moreover, the wear indication feature includes other surface characteristics such as texture and profile that are visibly distinct from the surrounding structure even after turbine engine system has been in operation, in order easily identify and measure the indicator.

The above-described wear inspection system and method of use provides a cost-effective and reliable method for inspecting internal components of a turbine for wear. In particular, the above-described wear inspection methods facilitate improving the quantitative assessment of determining the amount of wear of an internal component of the turbine, such as bucket tip covers. As such, the wear inspection methods permit an engineering evaluation that shortens the turbine outage time and further facilitates improving the efficiency of the turbine.

Exemplary embodiments of turbine buckets having wear indication features and methods of servicing the same are described above in detail. The methods and systems are not limited to the specific embodiments described herein, but rather, components of systems and/or steps of the method may be utilized independently and separately from other components and/or steps described herein. For example, the methods and systems may also be used in combination with other rotary engine systems and methods, and are not limited to practice with only the steam turbine engine as described herein. Rather, the exemplary embodiment can be implemented and utilized in connection with many other rotary system applications, for example gas turbine engines.

Although specific features of various embodiments of the disclosure may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples for disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine engine system comprising:
a component positioned such that said component is subject to wear, said component comprising:
an outer surface configured to be subjected to wear; and
a wear indication feature formed in said outer surface, wherein said wear indication feature includes a first dimension at said outer surface and a second dimension at an inward location relative to said outer surface, the second dimension being different from the first dimension.

2. The turbine engine system in accordance with claim 1 wherein said wear indication feature comprises a groove such that the first dimension comprises a first length and the second dimension comprises a second length.

3. The turbine engine system in accordance with claim 1 wherein the second dimension is larger than the first dimension.

4. The turbine engine system in accordance with claim 1 wherein said wear indication feature comprises at least one sidewall extending between said outer surface and said inward location.

5. The turbine engine system in accordance with claim 4 wherein said at least one sidewall is obliquely oriented with respect to said outer surface.

6. The turbine engine system in accordance with claim 4 wherein said at least one sidewall is arcuately-shaped.

7. A method of servicing a turbine engine, said method comprising:
forming at least one wear indication feature on a component of the turbine engine, the at least one wear indication feature including a first dimension;
operating the turbine engine such that the component is subjected to wear;
measuring the wear indication feature to determine a second dimension of the wear indication feature; and
determining a wear condition of the component based on the second dimension.

8. The method set forth in claim 7 further comprising determining a remaining service life of the component based on the determined wear condition.

9. The method set forth in claim 8 wherein determining a remaining service life of the gas turbine engine component comprises comparing the determined wear condition to a reference chart.

10. The method set forth in claim 7 wherein forming a wear indication feature on a component comprises forming a wear indication feature in a radially outer surface of the component.

11. The method set forth in claim 7 wherein forming a wear indication feature on a component comprises forming a wear indication feature in an outer surface of the component, and wherein measuring the wear indication feature comprises measuring the second dimension of the wear indication feature at a location normally inward of the outer surface.

12. The method set forth in claim 7 wherein determining a wear condition comprises comparing the first dimension to the second dimension.

13. The method set forth in claim 7 wherein the first dimension is larger than the second dimension.

14. The method set forth in claim 7 wherein the first dimension is smaller than the second dimension.

15. A wear indication system comprising:
a stationary component;
a rotating component positioned proximate said stationary component, said rotating component comprising:
a radially outer surface configured to contact said stationary component; and
a wear indication feature formed in said radially outer surface, wherein said wear indication feature includes a first dimension at said radially outer surface and a second dimension at a radially inward location of said radially outer surface, the second dimension being different from the first dimension.

16. The wear indication system in accordance with claim 15, wherein said stationary component comprises a turbine casing and said rotating component comprises a turbine rotor bucket tip cover.

17. The wear indication system in accordance with claim 15 wherein said wear indication feature is substantially circular such that the first dimension comprises a first diameter and the second dimension comprises a second diameter.

18. The wear indication system in accordance with claim 15 wherein the first dimension is larger than the second dimension.

19. The wear indication system in accordance with claim 15 wherein said rotating component comprises a thickness, said radially inward location spaced a predetermined depth from said radially outer surface, wherein the predetermined depth is associated with a wear condition of said rotating component.

20. The wear indication system in accordance with claim 15 wherein said wear indication feature comprises a frustoconical-shaped cavity formed in said radially outer surface.
